(19) United States
(12) Patent Application Publication
(10) Pub. No.: US 2025/0217531 A1
(43) Pub. Date: Jul. 3, 2025

(54) METHOD FOR AUTOMATICALLY GENERATING LOGICAL TOPOLOGY DIAGRAM, DEVICE AND MEDIUM

(71) Applicant: Persagy Science and Technology Co.,Ltd, Beijing (CN)

(72) Inventors: Qi SHEN, Beijing (CN); Xiaoyan PAN, Beijing (CN); Ting HAN, Beijing (CN); Lu MENG, Beijing (CN); Feifei LIU, Beijing (CN); Xuening Zhang, Beijing (CN)

(21) Appl. No.: 18/886,649

(22) Filed: Sep. 16, 2024

(30) Foreign Application Priority Data
Dec. 28, 2023 (CN) 202311830738.6

(51) Int. Cl. G06F 30/13

(52) U.S. Cl. CPC G06F 30/13

(57) ABSTRACT

Provided are a method for automatically generating a logical topology diagram, a device and a medium. The method includes steps described below. Physical world data of a target building is acquired, where the physical world data includes at least complete relationship representation information of spaces, systems and devices in the target building; a target relationship diagram template and a target device template are determined from pre-built candidate relationship diagram templates and pre-built candidate device templates according to the physical world data and a topology diagram generation requirement; and a target logical topology diagram corresponding to the topology diagram generation requirement is generated according to the target relationship diagram template and the target device template based on the complete relationship representation information in the physical world data.

### CROSS-REFERENCE TO RELATED APPLICATION

This application claims priority to Chinese Patent Application No. 202311830738.6, filed on Dec. 28, 2023, the disclosure of which is incorporated herein by reference in its entirety.

### TECHNICAL FIELD

The present disclosure relates to the field of software engineering and, in particular, to a method for automatically generating a logical topology diagram, a device and a medium.

### BACKGROUND

In intelligent systems related to infrastructure such as architecture, municipal engineering and transportation, system diagrams are widely used for expressing the composition structure and the operating state of an electromechanical system. Common examples include distribution system diagrams, heating station system diagrams and cold source system diagrams. A logical topology diagram is presented through a two-dimensional diagram, where specific physical connection relationships between figures are expressed through connecting lines between the figures, and thus the diagram composed of a complete system is drawn. Logical topology diagrams are not limited to expressing large-scale electromechanical systems and also widely used in various electromechanical systems, involving fields such as heating and ventilation, air conditioning, water supply and drainage, power transformation and distribution, Extra-Low Voltage (ELV) intelligence, fire protection and security and protection.

However, in intelligent software systems, to present such graphic representations, existing methods rely on engineers drawing on site. Drawing a large number of relationship diagrams and system diagrams in the intelligent software requires a high level of professional competence of on-site software implementation engineers, which leads to frequent errors in drawing relationship diagrams and frequent repeated rework during the implementation of a large number of actual software projects. Therefore, how to quickly, rigorously and efficiently generate logical topology diagrams automatically is an urgent problem that needs to be solved.

### SUMMARY

The present disclosure provides a method and apparatus for automatically generating a logical topology diagram, a device and a medium. A target logical topology diagram corresponding to a requirement is automatically generated through physical world data and candidate templates, so the precondition of relying on on-site manual drawing is avoided, and the breadth and the depth of the expression by intelligent software for electromechanical systems and devices are effectively improved.

According to an aspect of the present disclosure, a method for automatically generating a logical topology diagram is provided and is applied by a device for automatically generating a logical topology diagram. The device for automatically generating a logical topology diagram is disposed in an electromechanical system computer. The method includes steps described below.

Physical world data of a target building is acquired, where the physical world data includes at least complete relationship representation information of spaces, systems and devices in the target building.

A target relationship diagram template and a target device template are determined from pre-built candidate relationship diagram templates and pre-built candidate device templates according to the physical world data and a topology diagram generation requirement.

A target logical topology diagram corresponding to the topology diagram generation requirement is generated according to the target relationship diagram template and the target device template based on the complete relationship representation information in the physical world data.

According to another aspect of the present disclosure, an apparatus for automatically generating a logical topology diagram is provided. The apparatus includes a physical data acquisition module, a target template determination module and a topology diagram generation module.

The physical data acquisition module is configured to acquire physical world data of a target building, where the physical world data includes at least complete relationship representation information of spaces, systems and devices in the target building.

The target template determination module is configured to determine, according to the physical world data and a topology diagram generation requirement, a target relationship diagram template and a target device template from pre-built candidate relationship diagram templates and pre-built candidate device templates.

The topology diagram generation module is configured to generate, based on the complete relationship representation information in the physical world data, a target logical topology diagram corresponding to the topology diagram generation requirement according to the target relationship diagram template and the target device template.

According to another aspect of the present disclosure, an electronic device is provided and includes at least one processor and a memory communicatively connected to the at least one processor.

The memory stores a computer program executable by the at least one processor, and the computer program is executed by the at least one processor to cause the at least one processor to perform the method for automatically generating a logical topology diagram according to any embodiment of the present disclosure.

According to another aspect of the present disclosure, a computer-readable storage medium is provided. The computer-readable storage medium is configured to store computer instructions configured to, when executed by a processor, cause the processor to perform the method for automatically generating a logical topology diagram according to any embodiment of the present disclosure.

It is to be understood that the content described in this part is neither intended to identify key or important features of embodiments of the present disclosure nor intended to limit the scope of the present disclosure. Other features of the present disclosure are apparent from the description provided hereinafter.

### BRIEF DESCRIPTION OF DRAWINGS

To illustrate the technical solutions of the embodiments of the present disclosure more clearly, the drawings used in the description of the embodiments are described briefly hereinafter. Apparently, the drawings described below illustrate merely part of the embodiments of the present disclosure. Those of ordinary skill in the art may obtain other drawings based on these drawings on the premise that no creative work is done.

FIG. 1 is a flowchart of a method for automatically generating a logical topology diagram according to an embodiment of the present disclosure;

FIG. 2 is an architecture diagram of automatically generating a logical topology diagram applicable to embodiments of the present disclosure;

FIG. 3 is a template for a cold source system relationship diagram according to an embodiment of the present disclosure;

FIG. 4 is a typical example diagram of a legend repository according to an embodiment of the present disclosure;

FIG. 5 is a typical example diagram of an icon repository according to an embodiment of the present disclosure;

FIG. 6 is an automatically generated logical topology diagram according to an embodiment of the present disclosure;

FIG. 7 is a structural diagram of an apparatus for automatically generating a logical topology diagram according to an embodiment of the present disclosure; and

FIG. 8 is a structural diagram of an electronic device for implementing a method for automatically generating a logical topology diagram according to an embodiment of the present disclosure.

### DETAILED DESCRIPTION

For a better understanding of the solutions of the present disclosure by those skilled in the art, the technical solutions in the embodiments of the present disclosure are described clearly and completely below in conjunction with the drawings in the embodiments of the present disclosure. Apparently, the embodiments described below are merely part, not all, of the embodiments of the present disclosure. Based on the embodiments of the present disclosure, all other embodiments obtained by those of ordinary skill in the art on the premise that no creative work is done are within the scope of the present disclosure.

It is to be noted that the terms “candidate”, “target” and the like in the description, claims and the preceding drawings of the present disclosure are used for distinguishing between similar objects and are not necessarily used for describing a particular order or sequence. It is to be understood that the data used in this manner is interchangeable in appropriate cases so that the embodiments of the present disclosure described herein may be implemented in an order not illustrated or described herein. Additionally, terms “including” and “having” as well as any variations thereof are intended to encompass a non-exclusive inclusion. For example, a process, method, system, product or device that includes a series of steps or units not only includes the expressly listed steps or units but may also include other steps or units that are not expressly listed or are inherent to such a process, method, product or device.

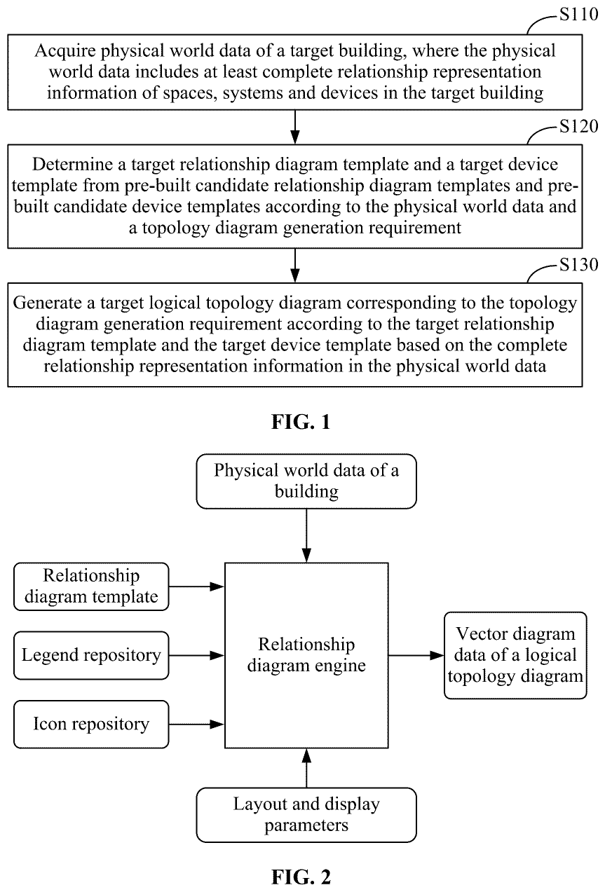

FIG. 1 is a flowchart of a method for automatically generating a logical topology diagram according to an embodiment of the present disclosure. The embodiment is applicable to the case of automatically generating a logical topology diagram. The method may be executed by an apparatus for automatically generating a logical topology diagram, which may be implemented in form of hardware and/or software and may be configured in an electromechanical system computer. As shown in FIG. 1, the method includes the steps described below.

In S110, physical world data of a target building is acquired, where the physical world data includes at least complete relationship representation information of spaces, systems and devices in the target building.

In the embodiment of the present application, FIG. 2 shows an overall architecture of automatically generating a logical topology diagram. A logical topology diagram is generated through three data drives, that is, a general data drive, a project data drive and a display data drive, respectively.

The target building refers to a specific building entity in the engineering field. The physical world data of the target building is the project data drive generated for a relationship diagram, may be understood as the digital form of the target building, and refers to the complete expression of objective physical information of a physical building, including spaces, systems, device objects, information points and relationship data in the physical building.

The method for automatically generating a logical topology diagram mainly aims at automatically generating a specified type of relationship diagram in the target building. Logical topology diagrams are not limited to expressing a large-scale electromechanical system and also widely used in various electromechanical systems, involving fields such as heating and ventilation, air conditioning, water supply and drainage, power transformation and distribution, ELV intelligence, fire protection and security and protection.

In S120, a target relationship diagram template and a target device template are determined from pre-built candidate relationship diagram templates and pre-built candidate device templates according to the physical world data and a topology diagram generation requirement.

In the embodiment of the present application, it is to be noted that the topology diagram generation requirement refers to the type of the logical topology diagram to be generated according to needs of the user. The layout and display parameters of the logical topology diagram are part of the personalized display requirements of the generation requirement, are the display data drive generated for the logical topology diagram, and includes an image dimension requirement and whether a graphic element is specified to be displayed or hidden.

The candidate relationship diagram templates and the candidate device templates are the general data drive generated for the relationship diagram and are independent from the target building project. The candidate relationship diagram templates and the candidate device templates are standardized representation of a certain type of electromechanical systems and devices, containing professional attribute information of composition, connection relationships and layout expressions of specific electromechanical systems. The candidate relationship diagram templates and the candidate device templates are pre-stored in a database by the system and to be called, and a target template type is determined from the candidate relationship diagram templates and the candidate device templates according to the specific data of the target building and the layout and display parameters of the topology diagram.

In an optional but not limited implementation, the candidate relationship diagram templates include composition structure information of multiple candidate electromechanical systems or candidate devices, where the composition structure information includes at least data logic and typesetting and layout, where the data logic represents screening information and relationship information of entity elements included in the candidate electromechanical systems or candidate devices corresponding to the candidate relationship diagram templates.

In the embodiment of the present application, the candidate relationship diagram templates include composition structure information of multiple electromechanical systems or devices. An example where a target relationship diagram is an air conditioning cooling system relationship diagram is illustrated, so a cooling tower relationship diagram template may be selected from the candidate relationship diagram templates as a general type of a data drive. A cooling tower device is the candidate device in the cooling tower relationship diagram.

The data logic of the relationship diagram template involves the logic of graphic elements and the connection line logic between graphic elements. The logic of graphic elements refers to graphic elements referred to by physical objects, such as floors, spaces, systems and devices, having specific information points. The connection line logic between graphic elements refers to that physical objects referred to by certain graphic elements satisfy a certain connection relationship. The data logic may be understood as floors and space forms and systems and device types included by the system or device referred to by a specific template, as well as a satisfied relationship logic screening condition.

According to the typesetting and layout of the relationship diagram template, a position condition for placing each graphic element in the image of the relationship diagram template can be determined, and relative position relationships, alignment relationships and connection relationships between graphic elements can be set. FIG. 3 is a cold source system relationship diagram template. In the cold source system diagram template, a cooling tower is placed at the top layer of the image and is aligned to the left, and a water distributor and a water collector are placed on the left and the right respectively as a whole in the middle of the image and are aligned to the center. For the connection of the water supply relationship between a chiller group and a primary single-stage chilled water pump, the connection point of the chiller is on the right side of the rectangular box, and the connection point of the chilled water pump is on the left side of the rectangular box.

In an optional but not limited implementation, the composition structure information includes benchmark object classes corresponding to the candidate electromechanical systems or the candidate devices, where the benchmark object classes are used for representing types of the candidate relationship diagram templates corresponding to the candidate electromechanical systems or the candidate devices, and one benchmark object class corresponds to at least one candidate relationship diagram template.

In an embodiment of the present application, the benchmark object classes and relationship diagram templates have a corresponding relationship, where a benchmark object class corresponds to one or more relationship diagram templates. For example, the benchmark object of a distribution system diagram is a low-voltage distribution system, and the benchmark object of a cooling tower structure relationship diagram is a cooling tower device.

In an optional but not limited implementation, the composition structure information further includes a template calling condition for the candidate relationship diagram templates, where the template calling condition includes structure feature difference judging information in at least two candidate relationship templates corresponding to the same benchmark object class.

In the embodiment of the present application, it is to be noted that the template calling condition is used for distinguishing between feature information of two or more candidate relationship diagram templates. Under different engineering conditions, each system or device may have different structure features, which directly leads to different composition structures of the system or the device, and thus systems or devices correspond to different templates. That is, for a same benchmark object class, multiple templates may exist. In actual use, a specific relationship diagram template used for a specific target building is distinguished by the template calling condition. The template calling condition is a logical judging combination that judges whether set information exists, a value condition and whether a relationship exists.

The template of a conventional cold source system diagram is taken as an example. The calling condition of this template includes no energy storage device, a single water distributor and no cold-station heat exchanger.

In an optional but not limited implementation, the step in which the target relationship diagram template is determined from the pre-built candidate relationship diagram templates according to the physical world data and the topology diagram generation requirement includes steps A1 to A2.

In step A1, a target benchmark object class and a target template calling condition are determined according to the topology diagram generation requirement.

In step A2, the target relationship diagram template is determined from the candidate relationship diagram templates according to the target benchmark object class and the target template calling condition.

In the embodiment of the present application, it is to be understood that the target benchmark object class that needs to be built is determined according to physical world actual data and computer system display data parameters, and then the target relationship diagram template is determined according to the target benchmark object class and the target template calling condition.

In an optional but not limited implementation, the candidate device templates are used for representing graphic representation information of candidate devices, and the candidate device templates include candidate device legend templates and candidate device icon templates, where the candidate device legend templates are used for representing general graphic presentation information of the candidate devices and collateral attribute information of the candidate devices, and the candidate device icon templates are used for representing concrete graphic presentation information of the candidate devices and connection attribute information of the candidate devices.

In the embodiment of the present application, it is to be noted that the candidate device templates include a device legend template repository and a device icon template repository. The device legend template repository includes graphic dimensions of each device of multiple devices and horizontal or vertical forms presented by the device when the device is in graphic representation. The legend repository contains fixed dimensions of each of spaces, each of systems and each of devices as well as related collateral general information and is a common resource repository of object graphic elements for calling in templates.

The icons in the device icon template repository are in one-to-one correspondence with the sets of graphic elements in the device legend template repository. Each graphic element corresponds to a set of icons. Icons are concrete expressions of spaces, systems and devices and are also a common resource repository of relationship diagrams.

In an optional but not limited implementation, the candidate device legend templates include at least legend identification information of the candidate devices, associated object type information of the candidate devices, general graphic size information of the candidate devices, general graphic connection point information of the candidate devices and general graphic annotation information of the candidate devices, and the candidate device icon templates include at least icon identification information, associated legend information, associated object type information and concrete graphic connection point offset information.

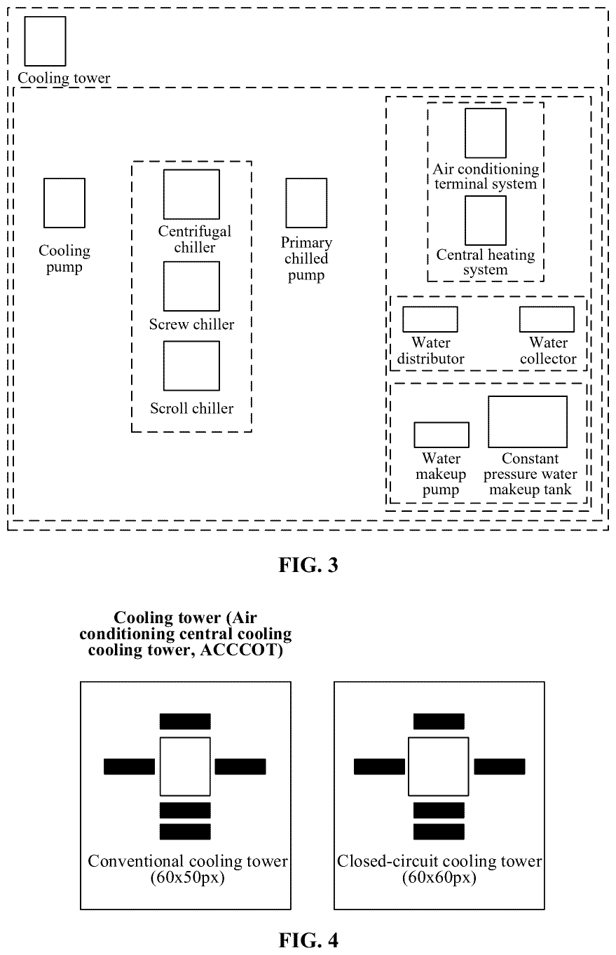

In the embodiment of the present application, FIG. 4 shows examples of graphic elements of cooling towers in the legend repository. Each graphic element contains a graphic element identifier (ID) and a graphic element name, an associated physical object type that matches a space, a system and a device which are defined by data standards, length and width dimensions of a rectangular graphic element, an anchor point position of a rectangle edge of the rectangular graphic element and a text marking box of the graphic element. The anchor point is a point position at a rectangle edge that can be connected, used for connecting two or more graphic elements. The text marking box is used for annotating graphic elements.

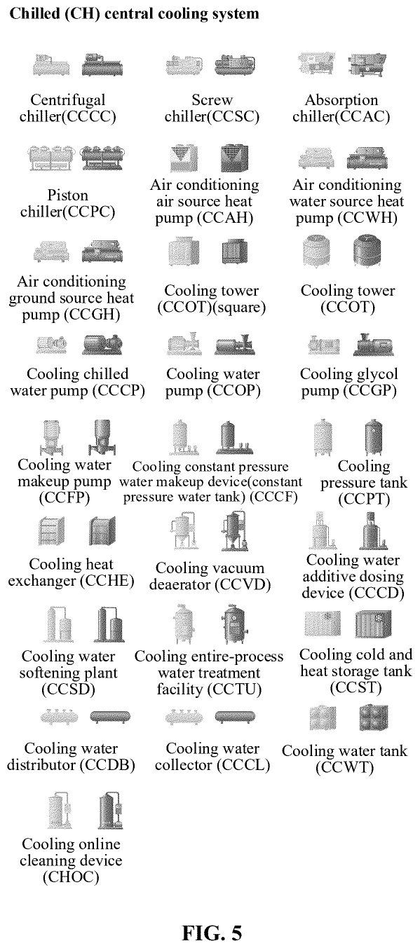

FIG. 5 shows examples of icon elements in the icon repository of chilled (CH) central cooling system. Each icon element contains an icon element ID and an icon element name, an associated graphic element ID and anchor point offset coordinates (x, y) of the corresponding graphic element. The anchor point offset coordinates (x, y) of the corresponding graphic element represent a relative offset of an anchor point on the graphic element. In FIG. 5, the letter combination “CC” at the begin of abbreviations represents central cooling (i.e., a central cooling system).

In S130, a target logical topology diagram corresponding to the topology diagram generation requirement is generated according to the target relationship diagram template and the target device template based on the complete relationship representation information in the physical world data.

In the embodiment of the present application, it is to be understood that the corresponding target logical topology diagram is generated through three drives, i.e., the physical world data drive, the template repository data drive and the topology diagram generation requirement data drive. In a given project, a system ID and the type of a target relationship diagram needing to be generated are specified first, and dimensions and displaying and hiding requirement parameters are illustrated. A relationship diagram engine will automatically generate a logically-correct logical topology diagram which is consistent with engineering drawing customs according to the physical world data in the project and based on the data logic and typesetting and layout rules of the relationship diagram template.

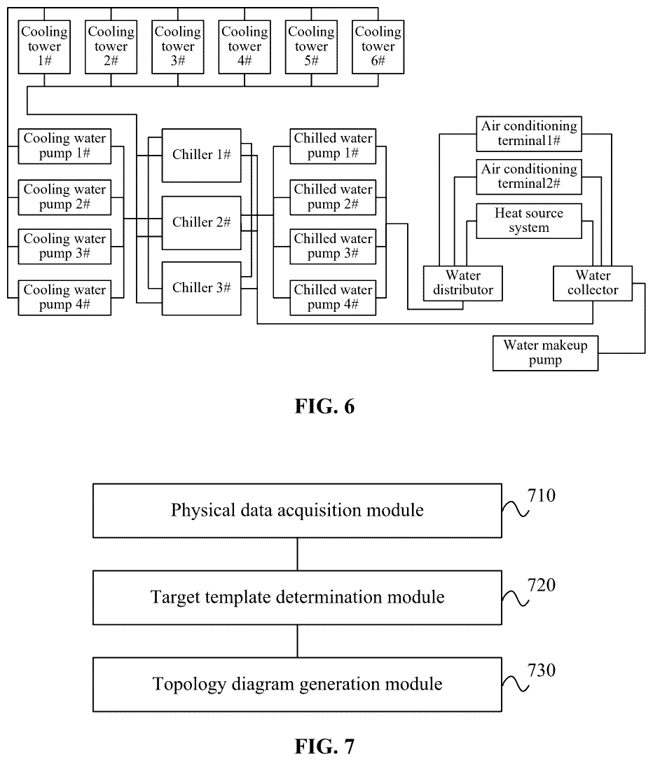

FIG. 6 shows an automatically generated logical topology diagram, which is provided in the manner of a vector diagram. Data of the diagram includes the outer contour and diagram coordinate points (for representing a position and dimensions) of a physical device, the graphic ID of the physical device, an array and relationship types of polylines of connecting lines, parallel line segments and specific line segments of connecting lines between graphic elements, coordinates of intersection points of line segments and whether the intersection points overlap.

The present disclosure discloses a method for automatically generating a logical topology diagram. The method includes steps described below. Physical world data of a target building is acquired, where the physical world data includes at least complete relationship representation information of spaces, systems and devices in the target building; a target relationship diagram template and a target device template are determined from pre-built candidate relationship diagram templates and pre-built candidate device templates according to the physical world data and a topology diagram generation requirement; and a target logical topology diagram corresponding to the topology diagram generation requirement is generated according to the target relationship diagram template and the target device template based on the complete relationship representation information in the physical world data. According to the technical solutions of the present disclosure, the target logical topology diagram corresponding to the requirement is automatically generated through the physical world data and the candidate templates, so the precondition of relying on on-site manual drawing is avoided, and the breadth and the depth of the expression by intelligent software for electromechanical systems and devices are effectively improved.

FIG. 7 is a structural diagram of an apparatus for automatically generating a logical topology diagram according to an embodiment of the present disclosure. As shown in FIG. 7, the apparatus includes a physical data acquisition module 710, a target template determination module 720 and a topology diagram generation module 730.

The physical data acquisition module 710 is configured to acquire physical world data of a target building, where the physical world data includes at least complete relationship representation information of spaces, systems and devices in the target building.

The target template determination module 720 is configured to determine, according to the physical world data and a topology diagram generation requirement, a target relationship diagram template and a target device template from pre-built candidate relationship diagram templates and pre-built candidate device templates.

The topology diagram generation module 730 is configured to generate, based on the complete relationship representation information in the physical world data, a target logical topology diagram corresponding to the topology diagram generation requirement according to the target relationship diagram template and the target device template.

Optionally, the target template determination module 720 includes the content described below.

The candidate relationship diagram templates include composition structure information of multiple candidate electromechanical systems or candidate devices, where the composition structure information includes at least data logic and typesetting and layout, where the data logic represents screening information and relationship information of entity elements included in the candidate electromechanical systems or candidate devices corresponding to the candidate relationship diagram templates.

Optionally, the composition structure information includes benchmark object classes corresponding to the candidate electromechanical systems or the candidate devices, where the benchmark object classes are used for representing types of the candidate relationship diagram templates corresponding to the candidate electromechanical systems or the candidate devices, and one benchmark object class corresponds to at least one candidate relationship diagram template.

Optionally, the composition structure information further includes a template calling condition for the candidate relationship diagram templates, where the template calling condition includes structure feature difference judging information in at least two candidate relationship templates corresponding to the same benchmark object class.

Optionally, the step in which the target relationship diagram template is determined from the pre-built candidate relationship diagram templates according to the physical world data and the topology diagram generation requirement includes steps A1 to A2.

In step A1, a target benchmark object class and a target template calling condition are determined according to the topology diagram generation requirement.

In step A2, the target relationship diagram template is determined from the candidate relationship diagram templates according to the target benchmark object class and the target template calling condition.

Optionally, the candidate device templates are used for representing graphic representation information of candidate devices, and the candidate device templates include candidate device legend templates and candidate device icon templates, where the candidate device legend templates are used for representing general graphic presentation information of the candidate devices and collateral attribute information of the candidate devices, and the candidate device icon templates are used for representing concrete graphic presentation information of the candidate devices and connection attribute information of the candidate devices.

Optionally, the candidate device legend templates include at least legend identification information of the candidate devices, associated object type information of the candidate devices, general graphic size information of the candidate devices, general graphic connection point information of the candidate devices and general graphic annotation information of the candidate devices, and the candidate device icon templates include at least icon identification information, associated legend information, associated object type information and concrete graphic connection point offset information.

The apparatus for automatically generating a logical topology diagram provided in the embodiment of the present disclosure can execute the method for automatically generating a logical topology diagram provided in any embodiment of the present disclosure and has function modules and beneficial effects corresponding to the method performed. For a process, reference is made to related operations in the method for automatically generating a logical topology diagram in the preceding embodiments.

In the technical solutions of the present application, the acquisition, storage, use and processing of data are in compliance with relevant provisions of national laws and regulations and do not violate public order and good customs.

According to an embodiment of the present disclosure, the present disclosure further provides an electronic device, a readable storage medium and a computer program product.

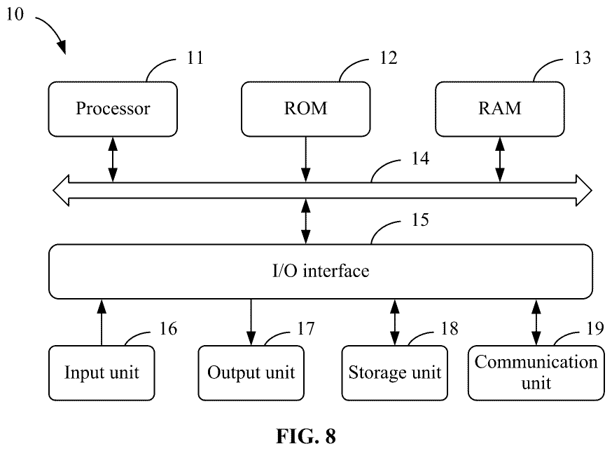

FIG. 8 is a structural diagram of an electronic device 10 for implementing the embodiments of the present disclosure. The electronic device is intended to represent various forms of digital computers, for example, a laptop computer, a desktop computer, a worktable, a personal digital assistant, a server, a blade server, a mainframe computer or another applicable computer. The electronic device may also represent various forms of mobile apparatuses, for example, a personal digital assistant, a cellphone, a smartphone, a wearable device (such as a helmet, glasses and a watch) or another similar computing apparatus. Herein the shown components, the connections and relationships between these components, and the functions of these components are illustrative and are not intended to limit the implementation of the present disclosure as described and/or claimed herein.

As shown in FIG. 8, the electronic device 10 includes at least one processor 11 and a memory (such as a read-only memory (ROM) 12 and a random-access memory (RAM) 13) communicatively connected to the at least one processor 11. The memory stores a computer program executable by the at least one processor. The processor 11 may perform various types of appropriate operations and processing according to a computer program stored in the ROM 12 or a computer program loaded from a storage unit 18 to the RAM 13. Various programs and data required for the operation of the electronic device 10 are also stored in the RAM 13. The processor 11, the ROM 12 and the RAM 13 are connected to each other through a bus 14. An input/output (I/O) interface 15 is also connected to the bus 14.

Multiple components in the electronic device 10 are connected to the I/O interface 15. The multiple components include an input unit 16 such as a keyboard or a mouse, an output unit 17 such as various types of displays or speakers, the storage unit 18 such as a magnetic disk or an optical disc, and a communication unit 19 such as a network card, a modem or a wireless communication transceiver. The communication unit 19 allows the electronic device 10 to exchange information/data with other devices over a computer network such as the Internet and/or various telecommunications networks.

The processor 11 may be various general-purpose and/or special-purpose processing components having processing and computing capabilities. Examples of the processor 11 include, but are not limited to, a central processing unit (CPU), a graphics processing unit (GPU), a special-purpose artificial intelligence (AI) computing chip, a processor executing machine learning models and algorithms, a digital signal processor (DSP) and any appropriate processor, controller and microcontroller. The processor 11 performs various methods and processing described above, such as the method for automatically generating a logical topology diagram.

In some embodiments, the method for automatically generating a logical topology diagram may be implemented as computer programs tangibly contained in a computer-readable storage medium such as the storage unit 18. In some embodiments, part or all of computer programs may be loaded and/or installed onto the electronic device 10 via the ROM 12 and/or the communication unit 19. When the computer programs are loaded to the RAM 13 and executed by the processor 11, one or more steps of the preceding method for automatically generating a logical topology diagram can be performed. Alternatively, in other embodiments, the processor 11 may be configured, in any other suitable manners (for example, by use of firmware), to perform the method for automatically generating a logical topology diagram.

Herein various embodiments of the systems and techniques described above may be implemented in digital electronic circuitry, integrated circuitry, field-programmable gate arrays (FPGAs), application-specific integrated circuits (ASICs), application-specific standard products (ASSPs), systems on chips (SOCs), complex programmable logic devices (CPLDs), computer hardware, firmware, software and/or combinations thereof. These embodiments may include implementations in one or more computer programs. The one or more computer programs may be executable and/or interpretable on a programmable system including at least one programmable processor. A programmable processor may be a special-purpose or general-purpose programmable processor for receiving data and instructions from a memory system, at least one input apparatus and at least one output apparatus and transmitting the data and instructions to the memory system, the at least one input apparatus and the at least one output apparatus.

Computer programs for implementation of the methods of the present disclosure may be written in one programming language or any combination of multiple programming languages. These computer programs may be provided for a processor of a general-purpose computer, a special-purpose computer or another programmable data processing apparatus such that the computer programs, when executed by the processor, cause functions/operations specified in the flowcharts and/or block diagrams to be implemented. These computer programs may be executed entirely on a machine, partly on a machine, as a stand-alone software package partly on a machine and partly on a remote machine, or entirely on a remote machine or a server.

In the context of the present disclosure, the computer-readable storage medium may be a tangible medium including or storing a computer program that is used by or used in conjunction with an instruction execution system, apparatus or device. The computer-readable storage medium may include, but is not limited to, an electronic, magnetic, optical, electromagnetic, infrared, or semiconductor system, apparatus, or device or any appropriate combination thereof. Alternatively, the computer-readable storage medium may be a machine-readable signal medium. Concrete examples of the machine-readable storage medium include an electrical connection based on one or more wires, a portable computer disk, a hard disk, a random-access memory (RAM), a read-only memory (ROM), an erasable programmable read-only memory (EPROM), a flash memory, an optical fiber, a portable compact disc read-only memory (CD-ROM), an optical storage device, a magnetic storage device or any suitable combination thereof.

In order that interaction with a user is provided, the systems and techniques described herein may be implemented on the electronic device. The electronic device has a display apparatus (for example, a cathode-ray tube (CRT) or a liquid-crystal display (LCD) monitor) for displaying information to the user; and a keyboard and a pointing apparatus (for example, a mouse or a trackball) through which the user can provide input for the electronic device. Other types of apparatuses may also be used for providing interaction with a user. For example, feedback provided for the user may be sensory feedback in any form (for example, visual feedback, auditory feedback or tactile feedback); and input from the user may be received in any form (including acoustic input, voice input or tactile input).

The systems and techniques described herein may be implemented in a computing system including a back-end component (for example, a data server), a computing system including a exchange component (for example, an application server), a computing system including a front-end component (for example, a user computer having a graphical user interface or a web browser through which a user can interact with embodiments of the systems and techniques described herein), or a computing system including any combination of such back-end, middleware or front-end components. Components of a system may be interconnected by any form or medium of digital data communication (for example, a communication network). Examples of the communication network include a local area network (LAN), a wide area network (WAN), a blockchain network and the Internet.

The computing system may include clients and servers. A client and a server are generally remote from each other and typically interact through a communication network. The relationship between the client and the server arises by virtue of computer programs running on respective computers and having a client-server relationship to each other. The server may be a cloud server, also referred to as a cloud computing server or a cloud host. As a host product in a cloud computing service system, the server solves the defects of difficult management and weak service scalability in a conventional physical host and virtual private server (VPS) services.

It is to be understood that various forms of the preceding flows may be used with steps reordered, added or deleted. For example, the steps described in the present disclosure may be performed in parallel, in sequence or in a different order as long as the desired result of the technical solutions provided in the present disclosure can be achieved. The execution sequence of these steps is not limited herein.

The scope of the present disclosure is not limited to the preceding embodiments. It is to be understood by those skilled in the art that various modifications, combinations, subcombinations and substitutions may be made according to design requirements and other factors. Any modification, equivalent substitution, improvement and the like made within the spirit and principle of the present disclosure fall within the scope of the present disclosure.

What is claimed is:

1. A method for automatically generating a logical topology diagram, comprising:
acquiring physical world data of a target building, wherein the physical world data comprises at least complete relationship representation information of spaces, systems and devices in the target building;
determining, according to the physical world data and a topology diagram generation requirement, a target relationship diagram template and a target device template from pre-built candidate relationship diagram templates and pre-built candidate device templates; and
generating, based on the complete relationship representation information in the physical world data, a target logical topology diagram corresponding to the topology diagram generation requirement according to the target relationship diagram template and the target device template.

2. The method according to claim 1, wherein the pre-built candidate relationship diagram templates comprise composition structure information of a plurality of candidate electromechanical systems or candidate devices, wherein the composition structure information comprises at least data logic and typesetting and layout, wherein the data logic represents screening information and relationship information of entity elements comprised in the plurality of candidate electromechanical systems or candidate devices corresponding to the pre-built candidate relationship diagram templates.

3. The method according to claim 2, wherein the composition structure information comprises benchmark object classes corresponding to the plurality of candidate electromechanical systems or candidate devices, wherein the benchmark object classes are used for representing types of the pre-built candidate relationship diagram templates corresponding to the plurality of candidate electromechanical systems or candidate devices, and one benchmark object class among the benchmark object classes corresponds to at least one candidate relationship diagram template.

4. The method according to claim 3, wherein the composition structure information further comprises a template calling condition for the pre-built candidate relationship diagram templates, wherein the template calling condition comprises structure feature difference judging information in at least two candidate relationship templates corresponding to a same benchmark object class.

5. The method according to claim 4, wherein determining, according to the physical world data and the topology diagram generation requirement, the target relationship diagram template from the pre-built candidate relationship diagram templates comprises:
determining a target benchmark object class and a target template calling condition according to the topology diagram generation requirement; and
determining, according to the target benchmark object class and the target template calling condition, the target relationship diagram template from the pre-built candidate relationship diagram templates.

6. The method according to claim 1, wherein the pre-built candidate device templates are used for representing graphic representation information of candidate devices, and the pre-built candidate device templates comprise candidate device legend templates and candidate device icon templates, wherein the candidate device legend templates are used for representing general graphic presentation information of the candidate devices and collateral attribute information of the candidate devices, and the candidate device icon templates are used for representing concrete graphic presentation information of the candidate devices and connection attribute information of the candidate devices.

7. The method according to claim 6, wherein the candidate device legend templates comprise at least legend identification information of the candidate devices, associated object type information of the candidate devices, general graphic dimension information of the candidate devices, general graphic connection point information of the candidate devices and general graphic annotation information of the candidate devices, and the candidate device icon templates comprise at least icon identification information, associated legend information, the associated object type information and concrete graphic connection point offset information.

8. An electronic device, comprising:
at least one processor; and
a memory communicatively connected to the at least one processor; wherein
wherein the memory stores a computer program executable by the at least one processor, and the computer program is executed by the at least one processor to cause the at least one processor to perform the following steps:
acquiring physical world data of a target building, wherein the physical world data comprises at least complete relationship representation information of spaces, systems and devices in the target building;
determining, according to the physical world data and a topology diagram generation requirement, a target relationship diagram template and a target device template from pre-built candidate relationship diagram templates and pre-built candidate device templates; and
generating, based on the complete relationship representation information in the physical world data, a target logical topology diagram corresponding to the topology diagram generation requirement according to the target relationship diagram template and the target device template.

9. The device according to claim 8, wherein the pre-built candidate relationship diagram templates comprise composition structure information of a plurality of candidate electromechanical systems or candidate devices, wherein the composition structure information comprises at least data logic and typesetting and layout, wherein the data logic represents screening information and relationship information of entity elements comprised in the plurality of candidate electromechanical systems or candidate devices corresponding to the pre-built candidate relationship diagram templates.

10. The device according to claim 9, wherein the composition structure information comprises benchmark object classes corresponding to the plurality of candidate electromechanical systems or candidate devices, wherein the benchmark object classes are used for representing types of the pre-built candidate relationship diagram templates corresponding to the plurality of candidate electromechanical systems or candidate devices, and one benchmark object class among the benchmark object classes corresponds to at least one candidate relationship diagram template.

11. The device according to claim 10, wherein the composition structure information further comprises a template calling condition for the pre-built candidate relationship diagram templates, wherein the template calling condition comprises structure feature difference judging information in at least two candidate relationship templates corresponding to a same benchmark object class.

12. The device according to claim 11, wherein determining, according to the physical world data and the topology diagram generation requirement, the target relationship diagram template from the pre-built candidate relationship diagram templates comprises:
determining a target benchmark object class and a target template calling condition according to the topology diagram generation requirement; and
determining, according to the target benchmark object class and the target template calling condition, the target relationship diagram template from the pre-built candidate relationship diagram templates.

13. The device according to claim 8, wherein the pre-built candidate device templates are used for representing graphic representation information of candidate devices, and the pre-built candidate device templates comprise candidate device legend templates and candidate device icon templates, wherein the candidate device legend templates are used for representing general graphic presentation information of the candidate devices and collateral attribute information of the candidate devices, and the candidate device icon templates are used for representing concrete graphic presentation information of the candidate devices and connection attribute information of the candidate devices.

14. The device according to claim 13, wherein the candidate device legend templates comprise at least legend identification information of the candidate devices, associated object type information of the candidate devices, general graphic dimension information of the candidate devices, general graphic connection point information of the candidate devices and general graphic annotation information of the candidate devices, and the candidate device icon templates comprise at least icon identification information, associated legend information, the associated object type information and concrete graphic connection point offset information.

15. A non-transitory computer-readable storage medium storing computer instructions configured to, when executed by a processor, cause the processor to perform the following steps:
acquiring physical world data of a target building, wherein the physical world data comprises at least complete relationship representation information of spaces, systems and devices in the target building;
determining, according to the physical world data and a topology diagram generation requirement, a target relationship diagram template and a target device template from pre-built candidate relationship diagram templates and pre-built candidate device templates; and
generating, based on the complete relationship representation information in the physical world data, a target logical topology diagram corresponding to the topology diagram generation requirement according to the target relationship diagram template and the target device template.

16. The medium according to claim 15, wherein the pre-built candidate relationship diagram templates comprise composition structure information of a plurality of candidate electromechanical systems or candidate devices, wherein the composition structure information comprises at least data logic and typesetting and layout, wherein the data logic represents screening information and relationship information of entity elements comprised in the plurality of candidate electromechanical systems or candidate devices corresponding to the pre-built candidate relationship diagram templates.

17. The medium according to claim 16, wherein the composition structure information comprises benchmark object classes corresponding to the plurality of candidate electromechanical systems or candidate devices, wherein the benchmark object classes are used for representing types of the pre-built candidate relationship diagram templates corresponding to the plurality of candidate electromechanical systems or candidate devices, and one benchmark object class among the benchmark object classes corresponds to at least one candidate relationship diagram template.

18. The medium according to claim 17, wherein the composition structure information further comprises a template calling condition for the pre-built candidate relationship diagram templates, wherein the template calling condition comprises structure feature difference judging information in at least two candidate relationship templates corresponding to a same benchmark object class.

19. The medium according to claim 18, wherein determining, according to the physical world data and the topology diagram generation requirement, the target relationship diagram template from the pre-built candidate relationship diagram templates comprises:
determining a target benchmark object class and a target template calling condition according to the topology diagram generation requirement; and
determining, according to the target benchmark object class and the target template calling condition, the target relationship diagram template from the pre-built candidate relationship diagram templates.

20. The medium according to claim 15, wherein the pre-built candidate device templates are used for representing graphic representation information of candidate devices, and the pre-built candidate device templates comprise candidate device legend templates and candidate device icon templates, wherein the candidate device legend templates are used for representing general graphic presentation information of the candidate devices and collateral attribute information of the candidate devices, and the candidate device icon templates are used for representing concrete graphic presentation information of the candidate devices and connection attribute information of the candidate devices.
